(19) United States
(12) Patent Application Publication
(10) Pub. No.: US 2008/0188226 A1
(43) Pub. Date: Aug. 7, 2008

(54) Telecommunication system and operating method

(76) Inventors: Tzu-Jane Tsai, Hsinchu County (TW); Jen-Shun Yang, Hsinchu County (TW)

Correspondence Address: Akin Gump LLP - Silicon Valley, 3000 El Camino Real, Two Palo Alto Square, Suite 400, Palo Alto, CA, 94306, US

(21) Appl. No.: 11/701,585

(22) Filed: Feb. 2, 2007

(51) Int. Cl. H04Q 7/20

(52) U.S. Cl. 455/443

(57) ABSTRACT

A telecommunication system includes a first cell and a second cell overlapping one another in an overlap region, a first base station in the first cell, a second base station in the second cell, a first relay station configured to provide a multi-hop relay function between the first base station and a first point in the overlap region closer to the second base station than the first base station, and a second relay station configured to provide a multi-hop relay function between the second base station and a second point in the overlap region closer to the first base station than the second base station, wherein the first base station and the first relay station in the first cell provide communication service to the mobile station till the mobile station moves to the first point in the overlap region.

### BACKGROUND OF THE INVENTION

The present invention generally relates to telecommunications and, more particularly, to a telecommunication system and an operating method capable of reducing handover.

In mobile telecommunications, it is allowed to handover between different base stations when mobile stations, such as cell phones, PDAs, notebooks, etc., are moving around or across the base stations. FIG. 1 is a schematic diagram illustrating a mobile station moving in a Manhattan-like environment. As illustrated in FIG. 1, in the Manhattan-like environment, a base station “BS” and a plurality of relay stations “RS” may be distributed in each of four cells 110, 120, 130 and 140. The arrows represent directions in which a mobile station may move from cell to cell in the example. As an example, the mobile station moves from a base station 121 in the cell 120 toward a relay station 112 in the cell 110, and turns right to move downward to the cell 130. When the mobile station is within the cell 120, the wireless communication service to the mobile station is provided by the base station 121 directly or via a relay station 124. When the mobile station enters the cell 110, the wireless communication service to the mobile station is provided by a base station 111 via a relay station 112. That is, a handover occurs. When the mobile station then enters the cell 130, the wireless communication service to the mobile station is provided by a base station 131 via a relay station 132. That is, another handover occurs.

For streaming traffic, the interference and data loss induced by the handover may be alleviated by certain recovery mechanism in higher layers. However, for voice traffic, the handover may cause annoyance to the users and may be difficult to overcome. In a Manhattan-like environment, the distance between two relay stations may be around 200 meters. Consequently, if a user in a car moving at 20 km/h in the Manhattan-like environment along the paths represented by the arrows, he may suffer two handovers within two minutes, which may be unacceptable.

It may therefore be desirable to have a system and a method capable of reducing the times of handover when a mobile station moves from cell to cell. Furthermore, it may also be desirable that the system and method may operate without departing from the communications standards such as, for example, IEEE 802.16e and IEEE 802.16j.

### BRIEF SUMMARY OF THE INVENTION

Examples of the present invention may provide telecommunication systems and related methods that utilize multiple hopping to reduce the handover in mobile communication.

One example of the present invention may provide a method configured for reducing handover in a telecommunication system. The method includes providing a plurality of cells, providing a base station and at least one relay station in each of the plurality of cells, each of the at least one relay station being configured to provide a multi-hop relay function, determining that a mobile station moves from a first cell toward a second cell of the plurality of cells, the first cell and the second cell overlapping one another in an overlap region, determining whether there is a second relay station in the overlap region provided in the second cell in a moving path when the mobile station moves from a first relay station provided in the first cell into the overlap region, providing communication service to the mobile station by a first station and the first relay station provided in the first cell in the absence of the second relay station in the overlap region in the moving path, and providing communication service to the mobile station by the first station provided in the first cell and the second relay station provided in the second cell in the presence of the second relay station in the overlap region in the moving path.

Another example of the present invention may provide a method configured for reducing handover in a telecommunication system. The method includes providing a first cell and a second cell, the first cell and the second cell overlapping one another in an overlap region, providing a first base station in the first cell and a second base station in the second cell, providing a first relay station in the first cell, the first relay station being configured to provide a multi-hop relay function between the first base station and a first point in the overlap region closer to the second base station than the first base station, providing a second relay station in the second cell, the second relay station being configured to provide a multi-hop relay function between the second base station and a second point in the overlap region closer to the first base station than the second base station, determining that a mobile station moves from the first cell toward the second cell, and providing communication service to the mobile station by the first base station and the first relay station provided in the first cell till the mobile station moves to the first point in the overlap region.

The other example of the present invention may provide a method configured for reducing handover in a telecommunication system. The method includes providing a plurality of cells, providing a base station and at least one relay station in each of the plurality of cells, providing each of the at least one relay station with a first transceiver for communication with a first base station and a second transceiver for communication with a second base station, determining that a mobile station moves from a first cell toward a second cell of the plurality of cells, the first cell and the second cell overlapping one another in an overlap region, and maintaining communication between the first base station and the mobile station till the mobile station moves away from the first cell.

Yet another example of the present invention may provide a telecommunication system. The telecommunication system includes a first cell and a second cell, the first cell and the second cell overlapping one another in an overlap region, a first base station in the first cell, a second base station in the second cell, a first relay station in the first cell, the first relay station being configured to provide a multi-hop relay function between the first base station and a first point in the overlap region closer to the second base station than the first base station, and a second relay station in the second cell, the second relay station being configured to provide a multi-hop relay function between the second base station and a second point in the overlap region closer to the first base station than the second base station, wherein the first base station and the first relay station in the first cell provide communication service to the mobile station till the mobile station moves to the first point in the overlap region.

Additional features and advantages of the present invention will be set forth in part in the description which follows, and in part will be obvious from the description, or may be learned by practice of the invention. The features and advantages of the invention will be realized and attained by means of the elements and combinations particularly pointed out in the appended claims.

It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The foregoing summary, as well as the following detailed description of the invention, will be better understood when read in conjunction with the appended drawings. For the purpose of illustrating the invention, there are shown in the drawings examples which are presently preferred. It should be understood, however, that the invention is not limited to the precise arrangements and instrumentalities shown.

In the drawings:

FIG. 1 is a schematic diagram illustrating a mobile station moving in a Manhattan-like environment;

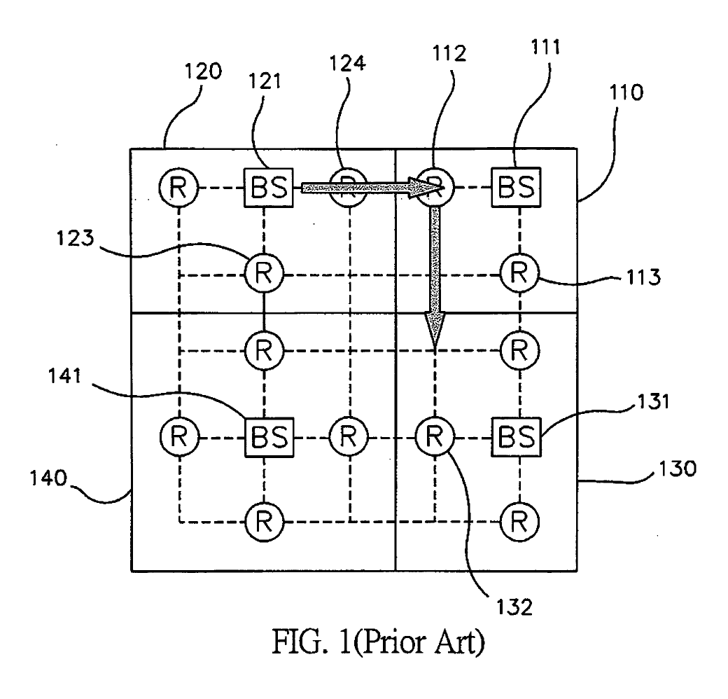

FIG. 2A is an exemplary diagram illustrating a method configured for reducing handovers in a Manhattan-like environment;

FIG. 2B is another exemplary diagram illustrating a method configured for reducing handovers in the Manhattan-like environment illustrated in FIG. 2A;

FIG. 3 is an exemplary diagram illustrating a method configured for reducing handovers in a Manhattan-like environment; and

FIG. 4 is a flow diagram illustrating a method configured for reducing handovers in a telecommunications system.

### DETAILED DESCRIPTION OF THE INVENTION

Reference will now be made in detail to the present examples of the invention illustrated in the accompanying drawings. Wherever possible, the same reference numbers will be used throughout the drawings to refer to the same or like portions.

In the present invention, a telecommunication system and a related operating method are provided to reduce the possibility of handover. As well known, cells are overlapped in many wireless systems. The concepts of cell overlapping and multiple hopping are utilized to introduce reduction of handover in the present invention.

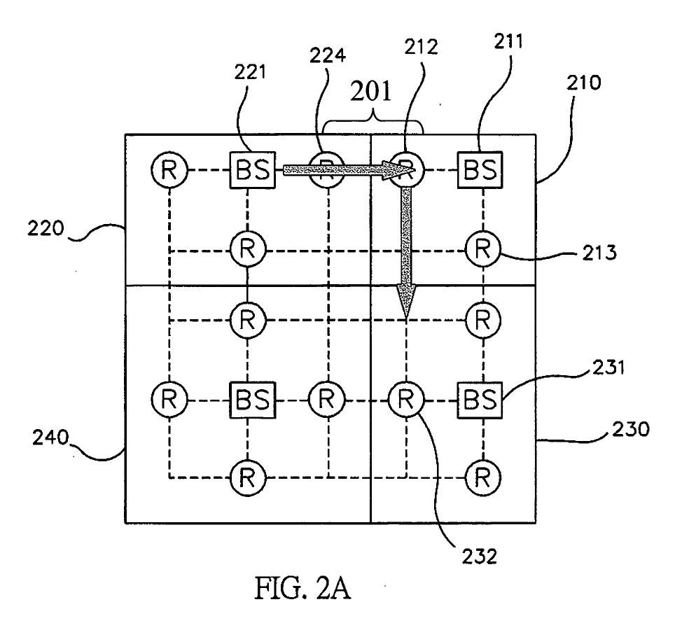

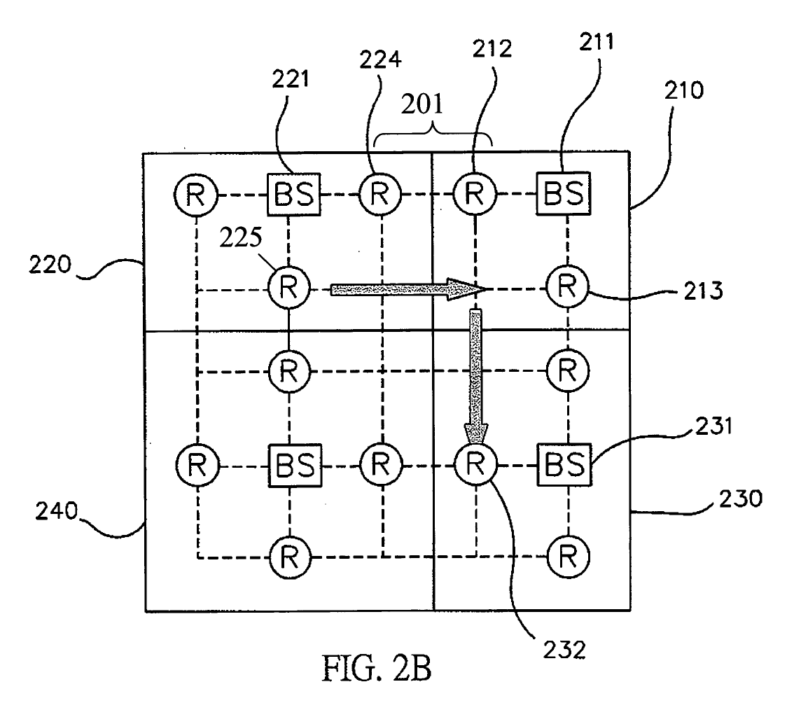

FIG. 2A is an exemplary diagram illustrating a method configured for reducing handovers in a Manhattan-like environment. The dotted lines represent streets and roads in the environment, and the arrows represent directions in which a mobile station, for example, a cell phone, a PDA, or a notebook, may move along the streets and roads. As illustrated in FIG. 2A, a base station and a plurality of relay stations may be provided in each of cells 210, 220, 230 and 240, in which neighboring cells may include a cell overlap region 201 common to one another. As an example, the mobile station moves from a base station 221 in the cell 220 toward a relay station 212 in the cell 210, and turns right to move downward to the cell 230. In an example consistent with the present invention, each of the relay stations may be configured to support a multi-hop relay function. Specifically, as an example, a first relay 224 may be configured to communicate with a first base station 221 within the same first cell 220 by a one-hop relay, and communicate with a second base station 211 in the second cell 210 by a two-hop relay. Similarly, a second relay 212 may be configured to communicate with the first base station 221 in the first cell 220 by a two-hop relay, and communicate with the second base station 211 within the same second cell 210 by a one-hop relay. To support the multi-hop relay function, each of the relays may include two pairs of transmitter/receiver to facilitate communication with multiple base stations. For instance, each of the relay stations may include a first transmitter/receiver pair or a first transceiver to communicate with one base station and a second transmitter/receiver pair or a second transceiver to communicate with another base station. In one example, the first relay station 224 and the second relay station 212 may be located within or near the overlap region 201 so as to support the two-hop relay.

As an example of the two-hop relay, when the mobile station is within the first cell 220, the wireless communication service to the mobile station is provided by the first base station 221 directly or via the first relay station 224. When the mobile station enters the second cell 210, the second relay 212, which is located in a cell overlap region between the first cell 220 and the second cell 210 and is configured to support two-hop relay, may take over the traffic from the first relay 224 to provide communication between the mobile station and the first base station 221. As a result, no handover is needed at the cell overlap region.

At this point, the mobile station may stay stationary with respect to the second base station 211, move further toward the second base station 211 or move downward toward the third cell 230. A handover does not occur and the first base station 221 continues to provide service until the signal strength at the second relay 212 is smaller than a threshold. In that case, if the signal strength becomes greater at the second base station 211 or at a relay 213, it is determined that the mobile station moves away from the second relay 212 toward the second base station 211. A handover is then taken place between the first and second base stations 221 and 211. If the signal strength becomes greater at a third base station 231 or a third relay 232 in the third cell 230, it is determined that the mobile station moves away from the second relay 212 toward the third base station 231. A handover is then taken place between the first and third base stations 221 and 231. In a conventional technique, as would generally be the case, a first handover occurs between the first and second base stations 221 and 211 when the mobile station travels from the first cell 220 to the second cell 210, and a second handover occurs between the second and third base stations 211 and 231 when the mobile station travels from the second cell 210 to the third cell 230. As compared to the conventional technique, one handover is eliminated by the method consistent with the example of the present invention.

FIG. 2B is another exemplary diagram illustrating a method configured for reducing handovers in the Manhattan-like environment illustrated in FIG. 2A. Referring to FIG. 2B, a mobile station may move from a relay station 225 in the first cell 220 toward the second cell 210. However, different from the example illustrated in FIG. 2A, when the mobile station moves in the overlap region 201, no immediate relay station like the relay station 212 illustrated in FIG. 2A is available. Skilled persons in the art will understand that in a communication system under the Manhattan-like environment, the distance between a base station and a relay station or between a relay station and its neighboring relay station is approximately 200 to 250 meters. It may therefore be possible that an immediate relay station is not available. However, since the relay station 225 may be configured to support the multi-hop relay, no handover is needed at the overlap region 201. The signal strength at the overlap region is detected to determine whether the mobile station stays stationary with respect to the second base station 211, moves further toward the second base station 211 or moves downward toward the third cell 230.

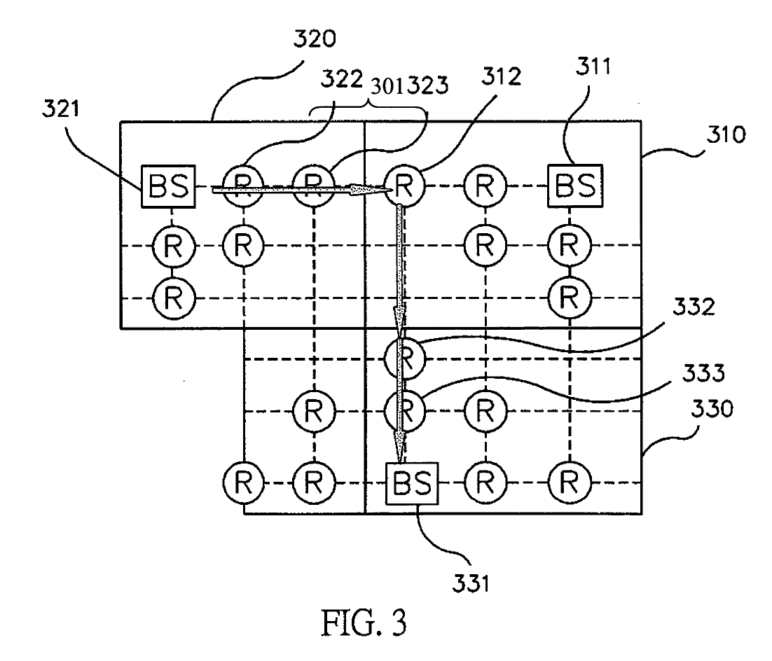

Triple hopping or higher multiple hopping may also be possible with the telecommunication system and method according to the present invention. FIG. 3 is an exemplary diagram illustrating a method configured for reducing handovers in a Manhattan-like environment. As compared to the examples shown in FIG. 2A and FIG. 2B, there are more than four relay stations distributed in each of the cells in the example in FIG. 3. As an example, a mobile station moves from a first base station 321 in a first cell 320 toward a relay station 312 in a second cell 310, and turns right to move downward to a third cell 330. In an example consistent with the present invention, each of the relay stations may be configured to support a multi-hop relay function. Specifically, as an example, a first relay 323 may be configured to communicate with a first base station 321 within the same first cell 320 by a two-hop relay, and communicate with a second base station 311 in the second cell 310 by a three-hop relay. Similarly, a second relay 312 may be configured to communicate with the first base station 321 in the first cell 320 by a three-hop relay, and communicate with the second base station 311 within the same second cell 310 by a two-hop relay. To support the multi-hop relay function, each of the relays may include two pairs of transmitter/receiver to facilitate communication with multiple base stations. In one example, the first relay station 323 and the second relay station 312 may be located within or near an overlap region 301 so as to support the three-hop relay.

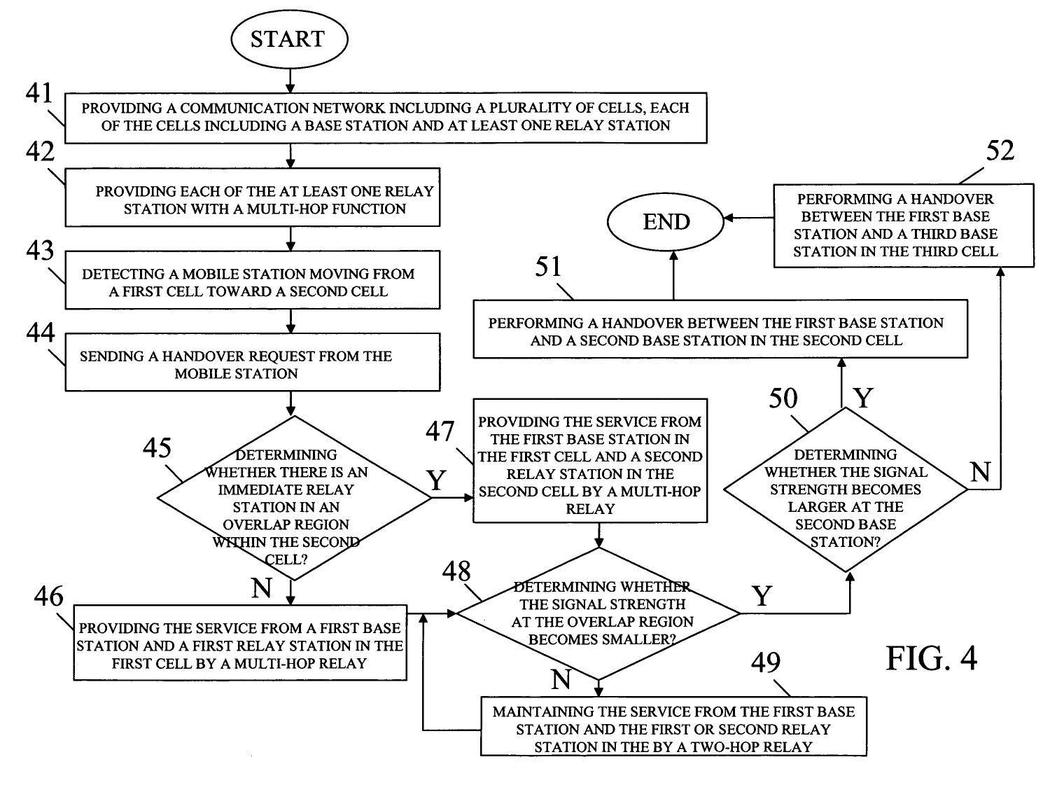

FIG. 4 is a flow diagram illustrating a method configured for reducing handovers in a telecommunications system. Referring to FIG. 4, at step 41, a plurality of cells may be provided in a communication network. Each of the cells may include a base station and at least one relay station. Furthermore, each of the cells may cover a communication range of a corresponding base station, and neighboring cells may overlap one another in an overlap region. At step 42, each of the at least one relay station is provided with a multi-hop relay function. In one example, each of the at least one relay includes a first transceiver or a first transmitter/receiver pair to communicate with a first base station and a second transceiver or a second transmitter/receiver pair to communicate with a second base station. Next, at step 43, a mobile station such as a cell phone or PDA moving from a first cell toward a second cell is detected. At step 44, a message regarding a request for handover is sent from the mobile station.

At step 45, it is determined whether there is an immediate relay station in the overlap region between the first cell and the second cell. If not, the communication service is provided by a first base station and a first relay station in the first cell, wherein the first relay station may be configured to support a multi-hop relay at a distance from a point in the overlap region. If confirmative, the communication service is provided by the first base station in the first cell and a second relay station in the second cell, wherein the second relay station may be configured to support a multi-hop relay at a distance from a point in the overlap region.

Next, at step 48, it is determined whether the signal strength at the overlap region becomes smaller than a threshold value. If not, which may mean that the mobile station stays stationary in the overlap region with respect to a second base station in the second cell, the communication service by the first base station and the first cell is maintained without any handover at step 49. If confirmative, which may mean that the mobile station moves away from the overlap region toward the second base station or a third station in a third cell, the signal strength is detected at step 50. If the detection reveals that the signal strength becomes greater than the threshold value at the second base station, at step 51, a handover is performed between the first base station and the second base station. If not, at step 52, a handover between the first base station and the third base station is performed.

In summary, the present invention provides a telecommunication system and the related operating methods that utilize multiple hopping for reducing the probability of handover such that the quality of real time traffic may be improved. In one example, the method according to the present invention may be implemented in a WiMAX system.

In describing representative examples of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

It will be appreciated by those skilled in the art that changes could be made to the examples described above without departing from the broad inventive concept thereof. It is understood, therefore, that this invention is not limited to the particular examples disclosed, but it is intended to cover modifications within the spirit and scope of the present invention as defined by the appended claims.

I/We claim:

1. A method configured for reducing handover in a telecommunication system, the method comprising:
providing a plurality of cells;
providing a base station and at least one relay station in each of the plurality of cells, each of the at least one relay station being configured to provide a multi-hop relay function;
determining that a mobile station moves from a first cell toward a second cell of the plurality of cells, the first cell and the second cell overlapping one another in an overlap region;
determining whether there is a second relay station in the overlap region provided in the second cell in a moving path when the mobile station moves from a first relay station provided in the first cell into the overlap region;
providing communication service to the mobile station by a first station and the first relay station provided in the first cell in the absence of the second relay station in the overlap region in the moving path; and
providing communication service to the mobile station by the first station provided in the first cell and the second relay station provided in the second cell in the presence of the second relay station in the overlap region in the moving path.

2. The method of claim 1 further comprising:
determining that signals in the overlap region become smaller than a threshold value in strength; and
performing a handover between the first base station and the second base station.

3. The method of claim 1 further comprising:
determining that signals in the overlap region become smaller than a threshold value in strength; and
performing a handover between the first base station and a third base station in a third cell of the plurality of cells.

4. The method of claim 1 further comprising:
providing each of the at least one relay station with a first transceiver for communication with the first station and a second transceiver for communication with the second base station.

5. The method of claim 1 further comprising:
providing the plurality of cells and the base station and at least one relay station in each of the plurality of cells in a Manhattan-like environment.

6. A method configured for reducing handover in a telecommunication system, the method comprising:
providing a first cell and a second cell, the first cell and the second cell overlapping one another in an overlap region;
providing a first base station in the first cell and a second base station in the second cell;
providing a first relay station in the first cell, the first relay station being configured to provide a multi-hop relay function between the first base station and a first point in the overlap region closer to the second base station than the first base station;
providing a second relay station in the second cell, the second relay station being configured to provide a multi-hop relay function between the second base station and a second point in the overlap region closer to the first base station than the second base station;
determining that a mobile station moves from the first cell toward the second cell; and
providing communication service to the mobile station by the first base station and the first relay station provided in the first cell till the mobile station moves to the first point in the overlap region.

7. The method of claim 6 further comprising:
determining that a mobile station moves from the second cell toward the first cell; and
providing communication service to the mobile station by the second base station and the second relay station provided in the second cell till the mobile station moves to the second point in the overlap region.

8. The method of claim 6 further comprising:
determining whether the mobile station moves toward the second cell via the second relay station; and
providing communication service to the mobile station by the first base station in the first cell and the second relay station provided in the second cell.

9. The method of claim 7 further comprising:
determining whether the mobile station moves toward the first cell via the first relay station; and
providing communication service to the mobile station by the second base station in the second cell and the first relay station provided in the first cell.

10. The method of claim 6 further comprising:
determining that signals in the overlap region are smaller than a threshold value in strength; and
performing a handover between the first base station and the second base station.

11. The method of claim 6 further comprising:
providing a third cell, the third cell and the second cell overlapping one another in a second overlap region;
determining that signals in the second overlap region are greater than a threshold value in strength; and
performing a handover between the first base station and a third base station in the third cell.

12. The method of claim 6 further comprising:
providing each of the first relay station and the second relay station with a first transceiver for communication with the first base station and a second transceiver for communication with the second base station.

13. The method of claim 11 further comprising:
providing a third relay station in the third cell; and
providing each of the first, second and third relay stations with a first transceiver for communication with one of the first, second and third base stations and a second transceiver for communication with another of the first, second and third base stations.

14. The method of claim 6 further comprising:
providing the first and second cells, the first and second base stations and the first and second relay stations in a Manhattan-like environment.

15. A method configured for reducing handover in a telecommunication system, the method comprising:
providing a plurality of cells;
providing a base station and at least one relay station in each of the plurality of cells;
providing each of the at least one relay station with a first transceiver for communication with a first base station and a second transceiver for communication with a second base station;
determining that a mobile station moves from a first cell toward a second cell of the plurality of cells, the first cell and the second cell overlapping one another in an overlap region; and
maintaining communication between the first base station and the mobile station till the mobile station moves away from the first cell.

16. The method of claim 15 further comprising:
determining whether there is a second relay station in the overlap region provided in the second cell in a moving path when the mobile station moves from a first relay station provided in the first cell into the overlap region; and
providing communication service to the mobile station by a first station and the first relay station provided in the first cell in the absence of the second relay station in the overlap region in the moving path.

17. The method of claim 15 further comprising:
determining whether there is a second relay station in the overlap region provided in the second cell in a moving path when the mobile station moves from a first relay station provided in the first cell into the overlap region; and
providing communication service to the mobile station by the first station provided in the first cell and the second relay station provided in the second cell in the presence of the second relay station in the overlap region in the moving path.

18. The method of claim 15 further comprising:
determining that signals in the overlap region become smaller than a threshold value in strength; and
performing a handover between the first base station and the second base station.

19. The method of claim 15 further comprising:
determining that signals in the overlap region become smaller than a threshold value in strength; and
performing a handover between the first base station and a third base station in a third cell of the plurality of cells.

20. A telecommunication system comprising:
a first cell and a second cell, the first cell and the second cell overlapping one another in an overlap region;
a first base station in the first cell;
a second base station in the second cell;
a first relay station in the first cell, the first relay station being configured to provide a multi-hop relay function between the first base station and a first point in the overlap region closer to the second base station than the first base station; and
a second relay station in the second cell, the second relay station being configured to provide a multi-hop relay function between the second base station and a second point in the overlap region closer to the first base station than the second base station,
wherein the first base station and the first relay station in the first cell provide communication service to the mobile station till the mobile station moves to the first point in the overlap region.

21. The system of claim 20, wherein the second base station and the second relay station in the second cell provide communication service to the mobile station till the mobile station moves to the second point in the overlap region.

22. The system of claim 20, wherein the second relay station is disposed between the first relay station and the second base station, and the first base station in the first cell and the second relay station in the second cell provide communication service to the mobile station in the overlap region.

23. The system of claim 21, wherein the first relay station is disposed between the second relay station and the first base station, and the second base station in the second cell and the first relay station in the first cell provide communication service to the mobile station in the overlap region.

24. The system of claim 20, wherein each of the first relay station and the second relay station includes a first transceiver for communication with the first base station and a second transceiver for communication with the second base station.

25. The system of claim 20 further comprising a third cell including a third base station and a third relay station, wherein each of the first, second and third relay stations includes a first transceiver for communication with one of the first, second and third base stations and a second transceiver for communication with another of the first, second and third base stations.

26. A telecommunication system comprising:
a plurality of cells including a first cell and a second cell, the first cell and the second cell overlapping one another in an overlap region;
a base station and at least one relay station in each of the plurality of cells; and
each of the at least one relay station includes a first transceiver for communication with a base station and a second transceiver for communication with another base station,
wherein the first base station maintains communication with the mobile station till the mobile station moves away from the first cell.
